(19) United States
(12) Patent Application Publication
(10) Pub. No.: US 2025/0052321 A1
(43) Pub. Date: Feb. 13, 2025

(54) FLAT GASKET FOR A SOLID OXIDE FUEL CELL, ARRANGEMENT AND SOLID OXIDE FUEL CELL WITH SUCH A FLAT GASKET

(71) Applicant: Reinz-Dichtungs-GmbH, Neu-Ulm (DE)

(72) Inventors: Oliver CLAUS, Laichingen (DE); Benjamin WITTMANN, Ulm (DE)

(21) Appl. No.: 18/799,487

(22) Filed: Aug. 9, 2024

(30) Foreign Application Priority Data
Aug. 11, 2023 (DE) 20 2023 104 563.4

(51) Int. Cl. F16J 15/08; H01M 8/2425; H01M 8/2485

(52) U.S. Cl. CPC F16J 15/0818; H01M 8/2425; H01M 8/2485

(57) ABSTRACT

The present disclosure relates to a flat gasket for sealing between a base plate and a stack of a plurality of electrochemical cells of a solid oxide fuel cell, with at least one metallic sealing layer in which sealing elements are embossed, characterized in that the metallic layer has at least one fixing point, wherein the fixing point has a structure, which projects from the surface of the metallic layer adjacent to the structure that forms an outer side of the flat gasket, and has at least one free edge in the projecting region.

### CROSS REFERENCE TO RELATED APPLICATION

The present application claims priority to German Utility Model Application No. 20 2023 104 563.4 entitled “FLAT GASKET FOR A SOLID OXIDE FUEL CELL, ARRANGEMENT AND SOLID OXIDE FUEL CELL WITH SUCH A FLAT GASKET”, filed Aug. 11, 2023. The entire contents of the above-identified application is hereby incorporated by reference for all purposes.

### TECHNICAL FIELD

The present disclosure relates to a flat gasket for arrangement between a base plate and a stack of electrochemical cells in a solid oxide fuel cell.

### BACKGROUND AND SUMMARY

Solid oxide fuel cells are high-temperature fuel cells whose electrolyte consists of a solid ceramic material. A fuel cell of this type has a stack of electrochemical cells arranged on a base plate. The supply of reactants and the discharge of products and unused reactants takes place via openings in the stack of electrochemical cells and the base plate, which extend in the stacking direction of the electrochemical cells.

A seal is therefore required between the base plate and the stack of electrochemical cells to prevent or minimize the leakage of products and educts through the gap between the base plate and the cell stack.

Due to the high temperatures in the range of 600° C. to 1200° C. at which a solid oxide fuel cell is operated, this seal is difficult to achieve with conventional seals. Even when using a metallic layer seal (MLS), the strong temperature fluctuations between operation and non-operation of the fuel cell result in relative movements between the base plate and the seal as well as between the seal and the cell stack, which impair the sealing effect.

Traditionally, relative movement is prevented by the base plate having stud bolts that engage in openings in the seal and thus secure it. However, this solution is structurally complex and cost-intensive.

Alternatively, in the prior art, the seal is completely inserted into flat pockets milled into the base plate for this purpose, the depth of which must be precisely determined so that the thickness of the seal is sufficient but does not exceed the depth of the milled pocket by too much. However, this requires a high degree of precision in the milling of the pockets in the base plate as well as very dimensionally accurate, flat seals that are centered in the flat milling pockets. Such gaskets inserted in milled pockets can hardly be pressed in the main force connection between the base plate and the cell stack. This further impairs the sealing effect of the gasket.

It is therefore the object of the present disclosure to provide a gasket, an arrangement comprising a base plate and a cell stack end plate and a solid oxide fuel cell which can be produced at low cost with a high sealing effect and minimized relative movements between a base plate of the solid oxide fuel cell and the gasket.

This object is at least partially addressed by the flat gasket, the arrangement, and the solid oxide fuel cell according to the present disclosure.

The flat gasket according to the present disclosure is used for sealing between a base plate and a stack of a plurality of electrochemical cells of a solid oxide fuel cell. It has at least one metallic sealing layer in which sealing elements are embossed. Such metallic seals are particularly suitable for sealing between two surfaces of two components at high temperatures and high pressures.

According to the present disclosure, the metallic layer has at least one fixing point. The fixing point has a structure that protrudes from the surface of the metallic layer adjacent to the structure that forms an outer side of the flat gasket. In other words, this structure protrudes beyond the adjacent surface of the metallic layer in the direction of one of the components between which the flat gasket is to seal. The structure has at least one free edge in the projecting region.

By means of the free edge of this structure, which can for example be a tab bent out of the metallic layer, the flat gasket can be positively fixed, in at least one direction in the plane of the metallic layer of the flat gasket, to the adjacent component, in particular to the base plate of a solid oxide fuel cell or also to the cell stack or another adjacent component. It is sufficient if the structure, for example the tab, engages in a recess in the surface of the neighboring component. If the flat gasket is only fixed by one free edge, movements in other directions in the plane of the metallic layer are still possible. By using suitably designed and positioned further structures of this type, it is also possible according to the present disclosure to fix the flat gasket to the adjacent component in other directions. It is always possible to use a suitable design to fix the flat gasket to the adjacent component with virtually no gap or with a little bit of scope in one, several or all directions.

The solution according to the present disclosure avoids the need to mill a pocket for the entire seal into the adjacent component, for example a base plate, and avoids the requirements for the accuracy of the milled pocket and the flat gasket associated with this solution, which is common in the prior art. Furthermore, the design of the flat gasket according to the present disclosure allows it to be arranged in the main force connection between the adjacent components to be sealed against each other, thus achieving an improved seal. The flat gasket is nevertheless able to absorb sliding forces between the components without being displaced in an impermissible manner in relation to a neighboring component.

A structure according to the present disclosure can be provided not only to fix the flat gasket to a (single) adjacent component. Rather, such structures according to the present disclosure can also be provided on both sides of the flat gasket in order to fix the flat gasket to both components between which the flat gasket is located.

It is also possible to arrange one or more of the structures according to the present disclosure in the same or different orientations on one or both sides of the flat gasket.

Solid oxide fuel cells often do not only have a single stack of electrochemical cells per base plate, but two or more stacks can also be arranged adjacent to each other on a base plate. In this case, it is possible to arrange a separate flat gasket according to the present disclosure on the base plate for each stack or to provide a flat gasket with a continuous metallic layer for two or more of the stacks or even for all stacks. If several stacks are arranged on a common flat gasket, it is also possible to arrange several of the structures according to the present disclosure on the flat gasket in order to fix the flat gasket in different regions on the base plate or to fix the flat gasket independently on individual stacks or on each of the stacks.

Optionally, the structure according to the present disclosure can be an embossed or bent structure. This makes it possible to form the structure in the metallic layer cost-effectively using bending or embossing techniques. In particular, the structure can be an embossed bead that has a free edge at at least one of its longitudinal ends. It can also have a free edge at both longitudinal ends of the bead, so that the bead is designed as a web extending transversely to the direction of the bead.

Optionally, the bead can be a full bead. However, it can also be designed as a half bead. If the structure is designed as a half bead, which has a free edge at both of its ends in the direction of the bead and also has a free edge at one of its ends in the transverse direction to the direction of the bead, the half bead forms a tab bent out of the plane of the metallic layer.

The structure can be an embossed or bent tab-also independent of a possible design as a half bead described above-which protrudes from the metallic layer out of the plane of the metallic layer and has a free edge at its projecting end.

Optionally, the bead, both as a full bead and as a half bead, has a substantially or completely flat bead top, at least in some regions, wherein advantageously the plane of the flat region of the bead top is substantially or completely parallel to the plane of the metallic layer adjacent to the bead.

Optionally, however, the bead can also have a substantially or completely rounded bead top at least in some regions and/or a tapered bead top at least in some regions, possibly on both sides.

The present disclosure also relates to an arrangement comprising a base plate and a stack end plate arranged on the base plate for a stack of one or more electrochemical cells of a solid oxide fuel cell, in which the base plate and/or the stack end plate have at least one recess and a flat gasket according to the present disclosure is arranged between the base plate and the stack end plate. The flat gasket is arranged with its structure according to the present disclosure in such a way that its projecting structure engages in the recess.

If there are several structures according to the present disclosure in the flat gasket, which protrude from the plane in the direction of the adjacent component, base plate or stack end plate, a recess must be arranged in the adjacent component for each of the structures, in which the structure can engage. It is possible to provide a recess for each of the structures or to provide a common recess for several of the structures. Alternatively, one or more structures can also be fixed to the outer edge of the base plate.

The present disclosure also relates to a solid oxide fuel cell with a base plate, at least one stack of one or more electrochemical cells and at least one stack end plate, which is arranged at the end of the stack facing the base plate between the base plate and the stack. The base plate and/or the stack end plate have at least one recess. A flat gasket according to the present disclosure is arranged between the base plate and the stack end plate. The flat gasket is arranged with its structure according to the present disclosure in such a way that its projecting structure engages in the recess.

The flat gasket has at least one metallic layer. However, it is also possible for the flat gasket to have several metallic layers. Any of the metallic layers may comprise the structures according to the present disclosure, but it is essential that, where a structure according to the present disclosure is disposed in one of the inner layers of the flat gasket, the structure must extend beyond the adjacent surface of the flat gasket to enable it to engage in a recess in the adjacent component. Optionally, however, the structures according to the present disclosure are located in one or both of the outer or outermost layers of the flat gasket and project beyond the outer surface of the respective layer adjacent to the respective structure in the plane of the layer.

The external shape of the flat gasket is not restricted in any way; the flat gasket can have smaller external dimensions than one or both of the adjacent components, in particular than the base plate or the stack end plate, either completely or only in certain regions. However, the flat gasket can also—completely or only in certain regions—protrude beyond the outer dimensions of one or both adjacent components, in particular the base plate or the stack end plate. It is also possible to precisely match the outer dimensions of the flat gasket to the outer dimensions of one or both adjacent components, either completely or only in certain regions.

One or more of the sealing elements of the flat gasket can be closed scaling beads. These can, for example, run around through-openings in the flat gasket or around the outer circumferential edge of the flat gasket.

The following materials are optionally used:
Spring steel, stainless steel or a nickel-based alloy for the flat gasket. The advantage of using a nickel-based alloy is that it is particularly suitable for use at high temperatures. It is also characterized by high creep resistance.
Die-cast, cast steel and stainless steel for the base plate.
Stainless steel, titanium or high-temperature alloys for the stack end plate.

Some examples of flat gaskets, arrangements and solid oxide fuel cells according to the present disclosure are given below. Identical and similar reference signs denote identical or similar elements. The description of the same reference numbers is therefore not always repeated. In the following examples, required and optional features of the present disclosure are shown together in each case. However, it is also possible to combine individual or several of the optional features of individual or several examples with each other without realizing further optional features.

### BRIEF DESCRIPTION OF THE FIGURES

FIG. 1 shows an arrangement of base plate and flat gasket.

FIGS. 2 to 5 are each sections of a flat gasket according to the present disclosure in an arrangement (partial figure A) and independently (partial figure B).

FIG. 6 shows an arrangement of a flat gasket in a solid oxide fuel cell according to the present disclosure.

### DETAILED DESCRIPTION

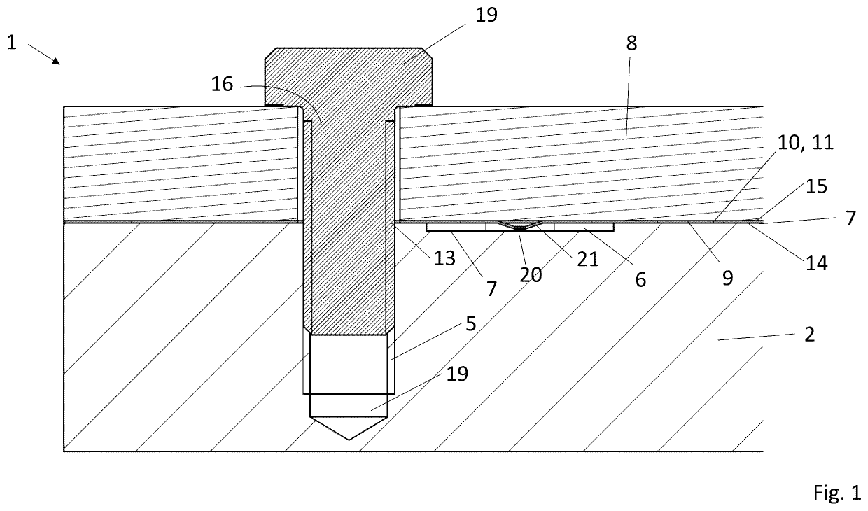

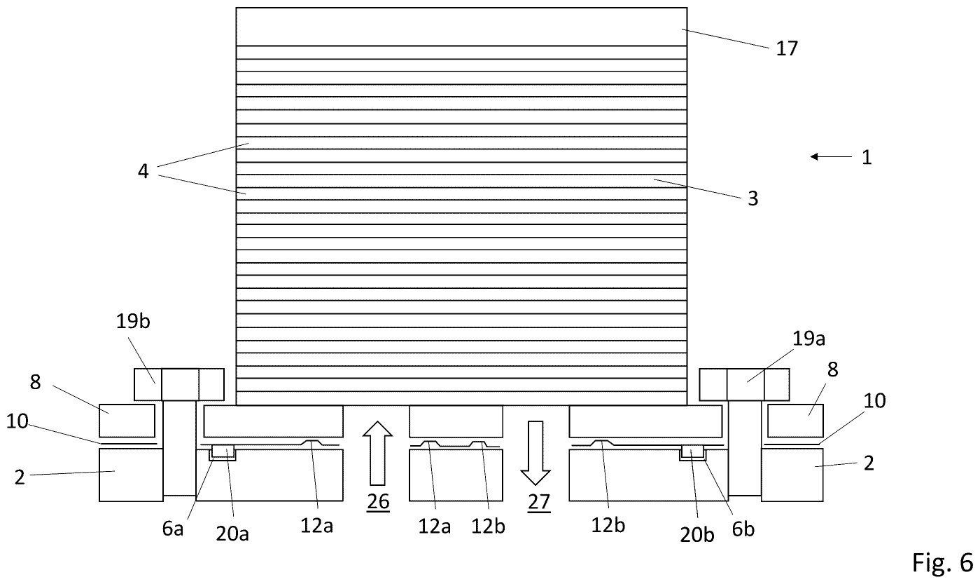

FIG. 1 shows in cross-section and in section around a fixing point 20 an arrangement of a solid oxide fuel cell 1, the arrangement having a base plate 2 and a flat gasket 10 with, in the present example, a metallic layer 11. Electrochemical cells 4 of a cell stack 3 of the fuel cell 1 are shown in FIG. 6.

The base plate has a surface 7 that faces the flat gasket 10. The flat gasket has a surface 14 that faces the base plate 2 and-not necessarily, but in this case-rests directly on the surface 7 of the base plate 2. The flat gasket 10 also has a surface 15 facing away from the base plate 2. As the flat gasket 10 only has one metallic layer 11 in this example, the surfaces 14 and 15 are also the surfaces of the metallic layer 11. Facing the surface 15 of the flat gasket 10 and the metallic layer 11 is a stack end plate 8 with a surface 9 facing the flat gasket 10.

The base plate 2, the flat gasket 10 and the stack end plate 8 each have a through-opening 5 or 13 and 16 for the passage of a screw 19 as fastening means in order to fix the stack end plate 8 and the flat gasket 10 to the base plate 2. Despite this screw connection, lateral displacement of the flat gasket 10 relative to the base plate 2 occurs due to the high temperatures and thus the strong temperature changes in the solid oxide fuel cell 1.

In order to limit these lateral displacements and absorb sliding forces, the base plate 2 has a flat recess 6 milled into its surface 7 facing the flat gasket 10. The flat gasket has a fixing point 20. This fixing point is designed as a web 21, which protrudes from the surface 14 of the flat gasket 10 facing the base plate 2 in the direction of the base plate 2 and engages in the recess 6. In the cross-section shown, this web 21 is designed as a full bead, which has a substantially flat, even bead top. The web 21 is embossed or bent out of the plane of the flat gasket 10. It has free edges running parallel to the drawing plane in front of and behind the drawing plane, with which the web 21 and thus the flat gasket 10 is positively fixed relative to the base plate 2 in a direction perpendicular to the drawing plane with a little bit of scope or without gap. This allows the web to absorb sliding forces in a direction perpendicular to the drawing plane and prevent excessive displacement of the flat gasket 10 relative to the base plate 2 in this direction.

However, the web does not fix the flat gasket 10 in a horizontal direction relative to the base plate 2 in the plane of the drawing and allows displacements in this direction. This displacement can be prevented or limited by the arrangement of a further fixing point, which is designed according to the present disclosure. For this purpose, a duplicate of the fixing point 20 can be arranged at a different position on the flat gasket 10 with the orientation of the web 21 rotated relative to the fixing point 20.

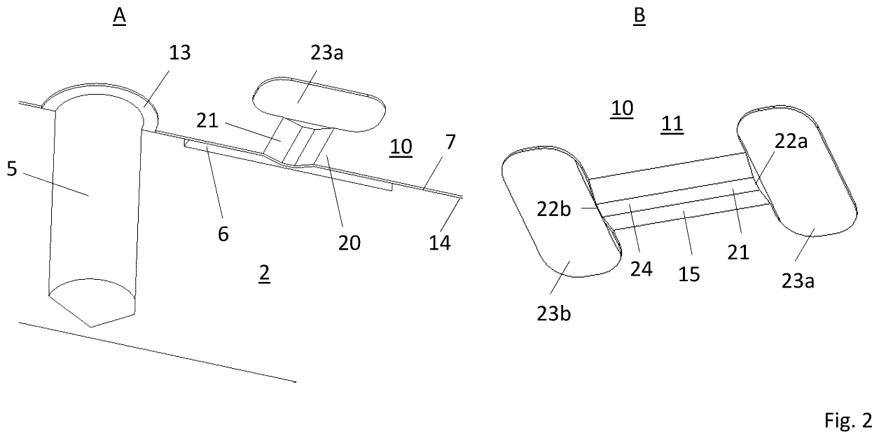

FIG. 2 shows in FIG. 2A an oblique plan view with cross-section of the arrangement in FIG. 1 in section and in FIG. 2B an oblique plan view of the metallic layer 11 of the flat gasket 10 without section.

The fixing point 20 has a web 21 exposed between two through-openings 23a and 23b, which is designed as a bead 21. The bead 21 extends with its longitudinal direction between the two openings 23a and 23b, so that the web forms free edges 22a and 22b as part of the peripheral edge of the openings 23a and 23b, which extend to both sides of the web 21. The bead 21 has a bead top 24, which is essentially flat and runs in the recess 6 when the flat gasket 10 is mounted on the base plate 2. The free edges 22a and 22b form stops on the adjacent edges of the recess 6 and therefore limit the displacement of the web 21 and thus of the metallic layer 11 of the flat gasket 10 in a form-fitting manner in the direction of the longitudinal extension of the bed top 24.

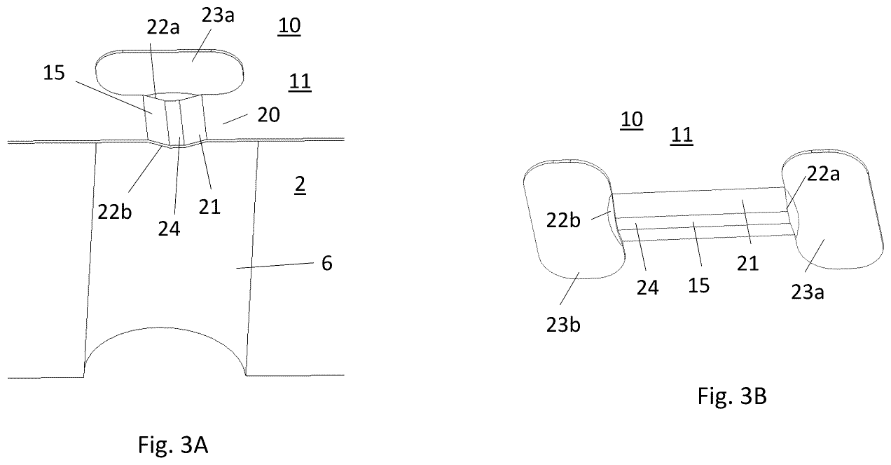

FIG. 3 shows in sub-figures A and B similar representations of a fixing point 20 as in FIGS. 2A and 2B. The metallic layer 11 of the flat gasket 10 is designed like the one in FIG. 2. In contrast to FIG. 2, however, the recess 6 in the base plate 2 is not designed as a flat cut-out, but as a round cross-section through-hole through the base plate 2. The free edges 22a and 22b of the web 21 now engage positively in the recess 6 of the base plate 2 and fix the metallic layer 11 of the flat gasket 10 in the same way as in FIG. 2.

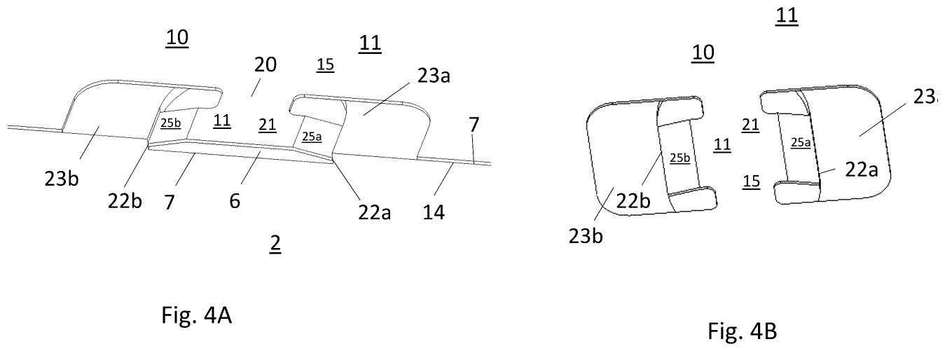

FIG. 4 shows in sub-figures A and B similar representations of a fixing point 20 as in FIGS. 2A and 2B. The recess 6 of the base plate 2 is essentially the same shape as the essentially rectangular flat cut-out in the surface 7 of the base plate 2 as in FIG. 2. Only the corners of the rectangular flat cut-out are rounded. In contrast to FIG. 2, the web 21 in FIG. 4 is not designed as a bead, the bead top 24 of which runs perpendicular to the longitudinal extent of the web 21 between the openings 23a and 23b and protrudes furthest in the direction of the base plate and engages in the recess 6. Rather, the web 21 is designed as a bead, which runs with its bead top 24 in the plane of the metallic layer 11 and whose bead top 24 runs between the connection points of the web 21 to the metallic layer 11. The free edges 22a and 22b of the web 21 facing the openings 23a and 23b and partially forming the circumferential edges of the openings 23a and 23b are bent out of the plane of the metallic layer 11 present in adjacent regions and the plane of the bead top 24 in the direction of the surface 7 of the base plate 2. The regions between the bead top 24 and the free edges 22a and 22b thus each form a tab 25a or 25b as flanks of the bead 21, which engage in the recess 6 of the base plate 2. This means that the free edges 22a and 22b also engage in the recess 6 in the surface 7 of the base plate 2 and limit the play of the flat gasket 10 in a form-fitting manner in the direction extending between the two openings 23a and 23b.

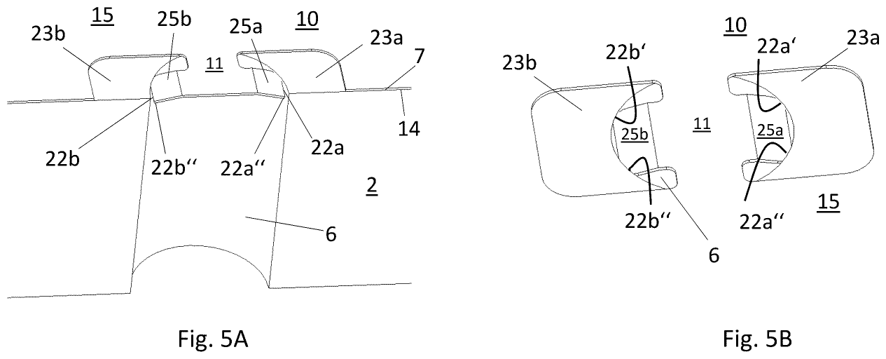

FIG. 5 shows a fixing point similar to that in FIG. 4. However, the corners of the free edges 22a and 22b of the tabs 25a and 25b engage in a round recess 6 of the base plate 2. Since the recess 6 for securing against displacement in the base plate 2 has a round cross-section, the free edges 22a and 22b do not touch the walls of the recess 6 over their entire length, but only the corners of the edges 22a′ and 22a″, as well as 22b′ and 22b″ fix the flat gasket 10. However, the flat gasket 10 in FIG. 5 is otherwise designed in the same way as the flat gasket 10 in FIG. 4.

FIG. 6 shows a structure of a solid oxide fuel cell 1 with base plate 2, flat gasket 10 according to the present disclosure, stack end plate 8 and electrochemical cells 4, which form a cell stack 3. The cell stack 3 is bounded at the upper end by an upper stack end plate 17. The flat gasket 10 according to the present disclosure contains sealing elements 12a and 12b, which surround the media inlet 26 and the media outlet 27, as well as two fixing points 20a and 20b according to the present disclosure, which engage in recesses 6a and 6b of the base plate 2. The fixing elements 20a and 20b are symbolized here as boxes and, in this example, secure the flat gasket 10 to the base plate 2 against displacement out of the drawing plane. The stack end plate 8 can therefore still move in all directions relative to the flat gasket 10.

### REFERENCE NUMBERS

1 fuel cell
2 base plate
3 cell stack
4 electrochemical cell(s)
5 hole for fastening element
6 recess in the base plate to prevent movement
7 surface of the base plate, oriented towards the flat gasket
8 stack end plate
9 surface of the stack end plate oriented towards the flat gasket
10 flat gasket
11 metallic layer(s)
12 sealing element
13 through-opening of the flat gasket for fastening element
14 surface of the flat gasket, oriented towards the base plate
15 surface of the flat gasket, oriented towards the stack end plate
16 through-opening of the stack end plate
17 upper stack end plate
19 fastening element (screw etc.)
20 fixing point(s)
21 projection(s)
22 free edge(s) or their corners
23 opening(s)
24 bead top
25 bead flank(s), tab(s)
26 media inlet
27 media outlet

1. A flat gasket for sealing between a base plate and a stack of a plurality of electrochemical cells of a solid oxide fuel cell, with at least one metallic sealing layer in which sealing elements are embossed,
wherein the at least one metallic sealing layer has at least one fixing point,
and wherein the at least one fixing point has a structure, which projects from a surface of the at least one metallic sealing layer adjacent to the structure that forms an outer side of the flat gasket, and has at least one free edge in the projecting region.

2. The flat gasket according to claim 1, wherein the structure is an embossed or bent structure.

3. The flat gasket according to claim 1, wherein the structure is an embossed bead which has a free edge at at least one of its longitudinal ends.

4. The flat gasket according to claim 3, wherein the embossed bead is a full bead.

5. The flat gasket according to claim 3, wherein the embossed bead has, at least in some regions, a substantially or completely flat bead top, wherein a plane of a flat region of the bead top is advantageously substantially or completely parallel to a plane of the at least one metallic sealing layer adjacent to the embossed bead.

6. The flat gasket according to claim 3, wherein the embossed bead has, at least in some regions, a substantially or completely rounded bead top and/or a bead top that at least in some regions tapers to a point, optionally from both sides.

7. The flat gasket according to claim 1, wherein the structure is an embossed or bent tab which protrudes from the at least one metallic sealing layer out of a plane of the at least one metallic sealing layer and has a free edge at its projecting end.

8. The flat gasket according to claim 1-, wherein the at least one metallic sealing layer has several fixing points with structures as described above.

9. An arrangement consisting of the base plate and a stack end plate arranged on the base plate for the stack of one or more electrochemical cells of the solid oxide fuel cell,
wherein
the base plate and/or the stack end plate have at least one recess, and wherein
the flat gasket according to claim 1 is arranged between the base plate and the stack end plate in such a way that a projecting structure of the flat gasket engages in the at least one recess.

10. The solid oxide fuel cell with the base plate, at least one stack of one or more electrochemical cells and at least one stack end plate, which is arranged at an end of the at least one stack facing the base plate between the base plate and the at least one stack,
wherein
the base plate and/or the at least one stack end plate have at least one recess, and wherein the flat gasket according to claim 1 is arranged between the base plate and the at least one stack end plate in such a way that a projecting structure of the flat gasket engages in the at least one recess.
